(19) United States
(12) Patent Application Publication
(10) Pub. No.: US 2026/0302034 A1
(43) Pub. Date: Oct. 1, 2026

(54) INDUCTOR COMPONENT

(71) Applicant: TDK Corporation, Tokyo (JP)

(72) Inventors: Tomohiro KAITO, Tokyo (JP); Kazuya TOBITA, Tokyo (JP); Munehiro TAKAKU, Tokyo (JP); Shinnosuke SUZUKI, Tokyo (JP)

(73) Assignee: TDK Corporation, Tokyo (JP)

(21) Appl. No.: 19/631,011

(22) Filed: Mar. 27, 2026

(30) Foreign Application Priority Data
Mar. 31, 2025 (JP) 2025-058549

(51) Int. Cl. H01F 17/00; H01F 27/29

(52) U.S. Cl. CPC H01F 17/0013; H01F 27/292

(57) ABSTRACT

An inductor component includes: an element body; a pair of terminal electrodes disposed in the element body; and an inductor disposed in the element body, in which the inductor includes: a first conductor extending in one direction and having one end in the one direction connected to one of the terminal electrodes; a second conductor extending in the one direction and having one end in the one direction connected to the other terminal electrode; and a coupling conductor connecting the other end of the first conductor in the one direction and the other end of the second conductor in the one direction, and a cross-sectional area of a cross section orthogonal to the one direction of at least one of the first conductor and the second conductor is larger than a cross-sectional area of a cross section orthogonal to an extending direction of the coupling conductor.

### TECHNICAL FIELD

The present disclosure relates to an inductor component.

### BACKGROUND

Japanese Unexamined Patent Publication No. 2021-52181 discloses an inductor component including: a base body having a mounting surface facing a circuit board, a top surface opposed to the mounting surface, and a first end surface connecting the mounting surface and the top surface; a first external electrode attached to the mounting surface of the base body; a second external electrode attached to the mounting surface of the base body, the second external electrode being spaced from the first external electrode in a length direction perpendicular to the end surface; and an internal conductor disposed in the base body, the internal conductor extending linearly from the first external electrode to the second external electrode in plan view from a thickness direction perpendicular to the mounting surface, one end of the internal conductor being exposed from the mounting surface and connected to the first external electrode, the other end of the internal conductor being exposed from the mounting surface and connected to the second external electrode.

### SUMMARY

An inductor component according to one aspect of the present disclosure includes: an element body; a pair of terminal electrodes disposed in the element body; and an inductor disposed in the element body, in which the inductor includes: a first conductor extending in one direction and having one end in the one direction connected to one of the terminal electrodes; a second conductor extending in the one direction and having one end in the one direction connected to the other terminal electrode; and a coupling conductor connecting the other end of the first conductor in the one direction and the other end of the second conductor in the one direction, and a cross-sectional area of a cross section orthogonal to the one direction of at least one of the first conductor and the second conductor is larger than a cross-sectional area of a cross section orthogonal to an extending direction of the coupling conductor.

### BRIEF DESCRIPTION OF THE DRAWINGS

FIG. 1 is a perspective view of an inductor component according to a first embodiment;

FIG. 2 is a view of the inductor component illustrated in FIG. 1 as viewed from a side of one end surface;

FIG. 3 is a view of the inductor component illustrated in FIG. 1 as viewed from a side of one side surface;

FIG. 4 is a view of the inductor component illustrated in FIG. 1 as viewed from a side of one main surface;

FIG. 5A is a view illustrating a cross section of a first pillar;

FIG. 5B is a view illustrating a cross section of a second pillar;

FIG. 5C is a view illustrating a cross section of a coupling conductor;

FIG. 6 is a perspective view of an inductor component according to a second embodiment;

FIG. 7 is a view of the inductor component illustrated in FIG. 6 as viewed from a side of one end surface;

FIG. 8 is a view of the inductor component illustrated in FIG. 6 as viewed from a side of one side surface;

FIG. 9 is a view of the inductor component illustrated in FIG. 6 as viewed from a side of one main surface;

FIG. 10A is a view illustrating a cross section of a first pillar;

FIG. 10B is a view illustrating a cross section of a second pillar;

FIG. 10C is a view illustrating a cross section of a coupling conductor;

FIG. 11 is a perspective view of an inductor component according to a third embodiment;

FIG. 12 is a view of the inductor component illustrated in FIG. 11 as viewed from a side of one end surface;

FIG. 13 is a view of the inductor component illustrated in FIG. 11 as viewed from a side of one side surface;

FIG. 14 is a view of the inductor component illustrated in FIG. 11 as viewed from a side of one main surface;

FIG. 15A is a view illustrating a cross section of a first pillar;

FIG. 15B is a view illustrating a cross section of a second pillar; and

FIG. 15C is a view illustrating a cross section of a coupling conductor.

### DETAILED DESCRIPTION

### Problems to be Solved by the Present Disclosure

In the inductor component, the value of inductance (hereinafter, “inductance value”) is set according to the length of the conductor constituting the inductor. As the inductor component, an inductor component having a low inductance value may be required. In the inductor component having a low inductance value, adjustment of the inductance value is not easy.

An object of one aspect of the present disclosure is to provide an inductor component capable of easily adjusting an inductance value.

### Effects of Present Disclosure

According to one aspect of the present disclosure, the inductance value can be easily adjusted.

### Description of Embodiments of Present Disclosure

First, contents of embodiments of the present disclosure will be listed and described. At least some of the embodiments described below may be arbitrarily combined.

(1) An inductor component according to one aspect of the present disclosure includes: an element body; a pair of terminal electrodes disposed in the element body; and an inductor disposed in the element body, in which the inductor includes: a first conductor extending in one direction and having one end in the one direction connected to one of the terminal electrodes; a second conductor extending in the one direction and having one end in the one direction connected to the other terminal electrode; and a coupling conductor connecting the other end of the first conductor in the one direction and the other end of the second conductor in the one direction, and a cross-sectional area of a cross section orthogonal to the one direction of at least one of the first conductor and the second conductor is larger than a cross-sectional area of a cross section orthogonal to an extending direction of the coupling conductor.

In the inductor component according to one aspect of the present disclosure, the cross-sectional area of the cross section orthogonal to the one direction of at least one of the first conductor and the second conductor is larger than the cross-sectional area of the cross section orthogonal to the extending direction of the coupling conductor. As described above, in the inductor component, the inductance value of the inductor can be reduced by making the cross-sectional area of at least one of the first conductor and the second conductor larger than the cross-sectional area of the coupling conductor. As a result, in the inductor component, the inductance value can be adjusted by the coupling conductor after the inductance value is reduced. Therefore, in the inductor component, the inductance value can be easily adjusted (set).

(2) In the inductor component according to the above (1), a plurality of the inductors may be disposed in the element body, and the plurality of the inductors may be electrically connected in parallel. In this configuration, the inductance value of the inductor component can be set according to the number of inductors.

(3) In the inductor component according to the above (1) or (2), the element body may be formed of a material having light permeability. In this configuration, the internal structure of the element body can be confirmed. Therefore, in the inductor component, a surface other than the mounting surface of the element body on which the terminal electrode is disposed can be visually distinguished based on the internal structure of the element body.

(4) In the inductor component according to the above (3), the element body may include a mounting surface on which the pair of terminal electrodes is disposed, and a main surface opposed to the mounting surface in the one direction, and the coupling conductor may be disposed at a position closer to the main surface than a center in the one direction in the element body. In this configuration, since the coupling conductor is disposed at a position closer to the main surface than the center in the one direction, the coupling conductor can be visually recognized from the main surface side when the element body is formed of a material having light permeability. As a result, in the inductor component, a surface other than the mounting surface of the element body on which the terminal electrode is disposed can be visually distinguished.

(5) In the inductor component according to any one of the above (1) to (4), the element body may include a mounting surface on which the pair of terminal electrodes is disposed, and a main surface opposed to the mounting surface in the one direction, and the pair of terminal electrodes may be disposed only on the mounting surface. The pair of terminal electrodes may be so-called bottom surface terminals.

(6) In the inductor component according to any one of the above (1) to (5), at least one of the first conductor and the second conductor may have the same width as the coupling conductor. In this configuration, it is possible to suppress that the cross-sectional area between at least one of the first conductor and the second conductor and the coupling conductor changes rapidly (at once). As a result, in the inductor component, it is possible to suppress a decrease in a Q value due to a rapid change in the cross-sectional area.

(7) In the inductor component according to any one of the above (1) to (6), the cross-sectional area of at least one of the first conductor and the second conductor may be 0.02 times or more the cross-sectional area of the terminal electrode orthogonal to the one direction. In this configuration, it is possible to suppress that the cross-sectional area between at least one of the first conductor and the second conductor and the terminal electrode changes rapidly. As a result, in the inductor component, it is possible to suppress a decrease in a Q value due to a rapid change in the cross-sectional area.

(8) In the inductor component according to any one of the above(1) to (7), a cross-sectional area of a cross section orthogonal to the one direction of the first conductor and a cross-sectional area of a cross section orthogonal to the one direction of the second conductor may be the same.

(9) In the inductor component according to any one of the above (1) to (8), cross sections orthogonal to the one direction of the first conductor and the second conductor and a cross section orthogonal to the extending direction of the coupling conductor may be rectangular.

(10) In the inductor component according to any one of the above (1) to (9), the element body may have a rectangular parallelepiped shape.

(11) In the inductor component according to any one of the above (1) to (10), the element body may be a laminate formed by laminating a plurality of element body layers in the one direction.

(12) In the inductor component according to any one of the above (1) to (11), the element body may contain a resin.

(13) In the inductor component according to the above (2), the plurality of the inductors may be arranged side by side in a third direction orthogonal to the one direction and the extending direction of the coupling conductor.

(14) In the inductor component according to the above (13), the plurality of the inductors may be two.

(15) In the inductor component according to the above (13), the plurality of the inductors may be three.

(16) In the inductor component according to the above (4), the pair of terminal electrodes may be disposed only on the mounting surface.

(17) In the inductor component according to the above (5), surfaces of the pair of terminal electrodes may be flush with the mounting surface.

(18) In the inductor component according to the above (6), a length in a direction orthogonal to the width in a cross section orthogonal to the one direction of at least one of the first conductor and the second conductor may be larger than a length in a direction orthogonal to the width in a cross section orthogonal to the extending direction of the coupling conductor.

(19) In the inductor component according to the above (7), the cross-sectional area of at least one of the first conductor and the second conductor may be 1.0 times or less the cross-sectional area of the terminal electrode orthogonal to the one direction.

(20) In the inductor component according to the above (1), the element body may include a mounting surface on which the pair of terminal electrodes is disposed, and a pair of end surfaces continuous from the mounting surface, one of the terminal electrodes may be disposed across one of the end surfaces and the mounting surface, and the other of the terminal electrodes may be disposed across the other of the end surfaces and the mounting surface.

### Details of Embodiments of Present Disclosure

Specific examples of embodiments of the present disclosure will be described below with reference to the drawings. The present disclosure is not limited to these examples, but is indicated by the claims, and is intended to include all modifications within the meaning and scope equivalent to the claims. In the description of the drawings, the same elements are denoted by the same reference numerals, and redundant description thereof will be omitted.

### First Embodiment

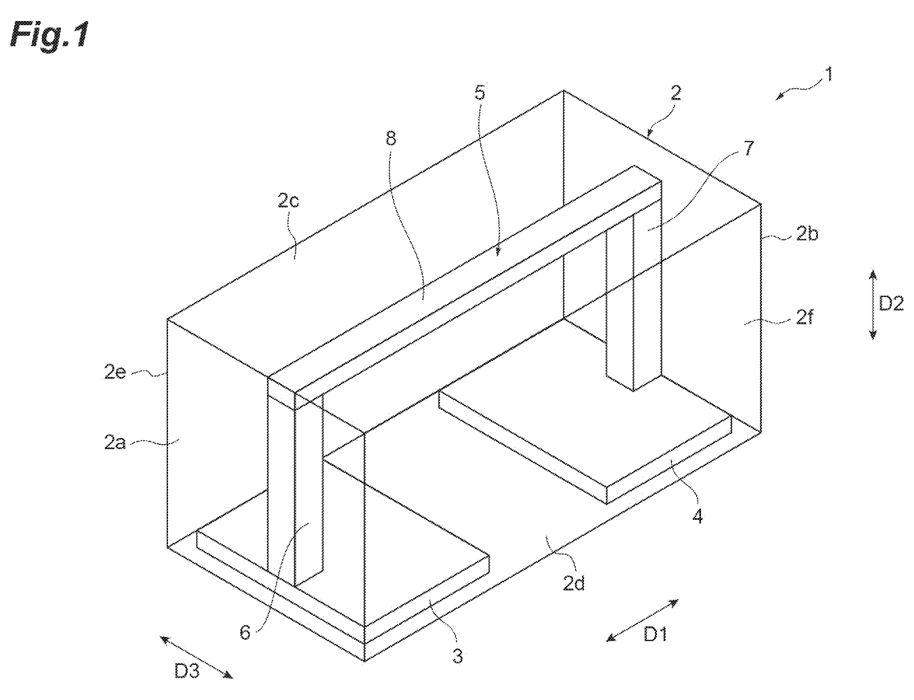

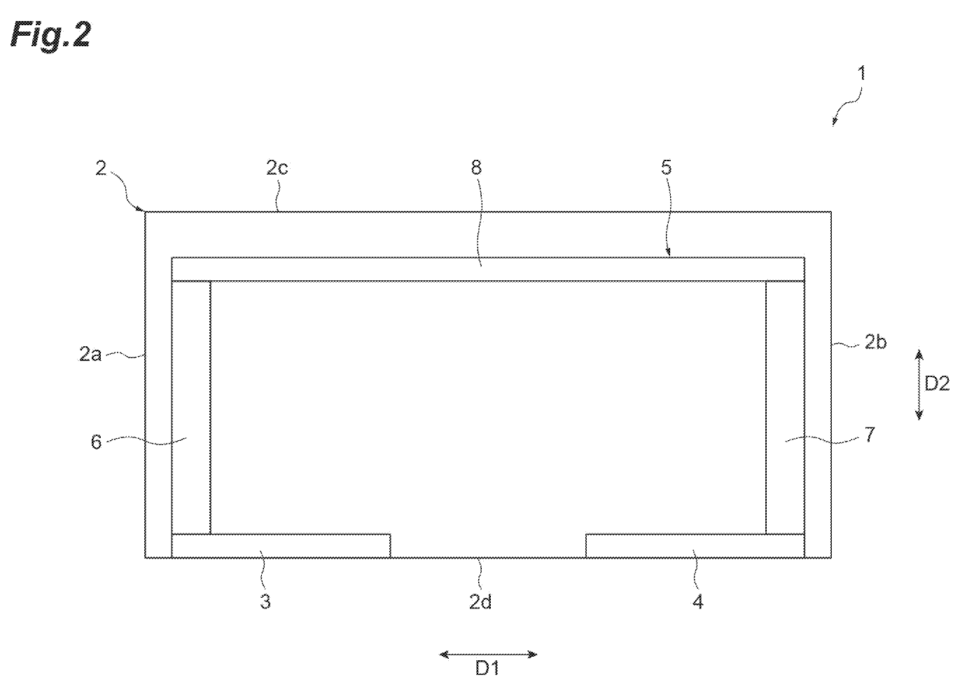

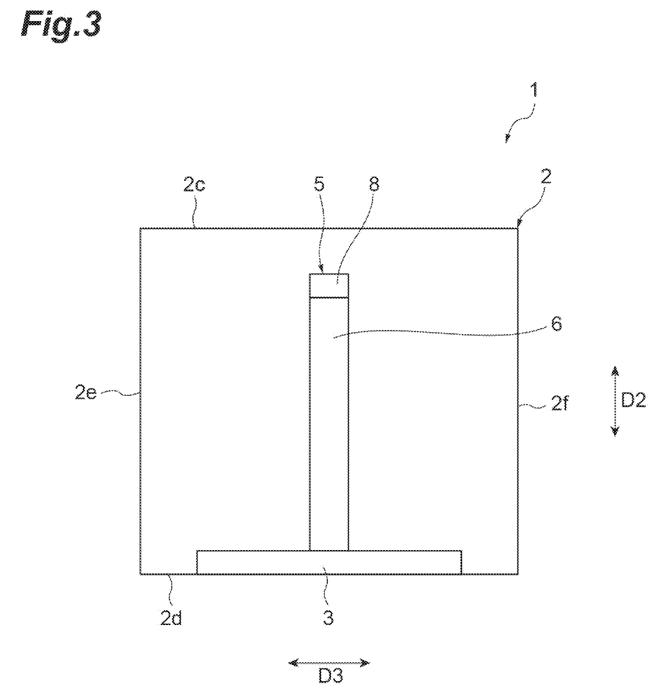

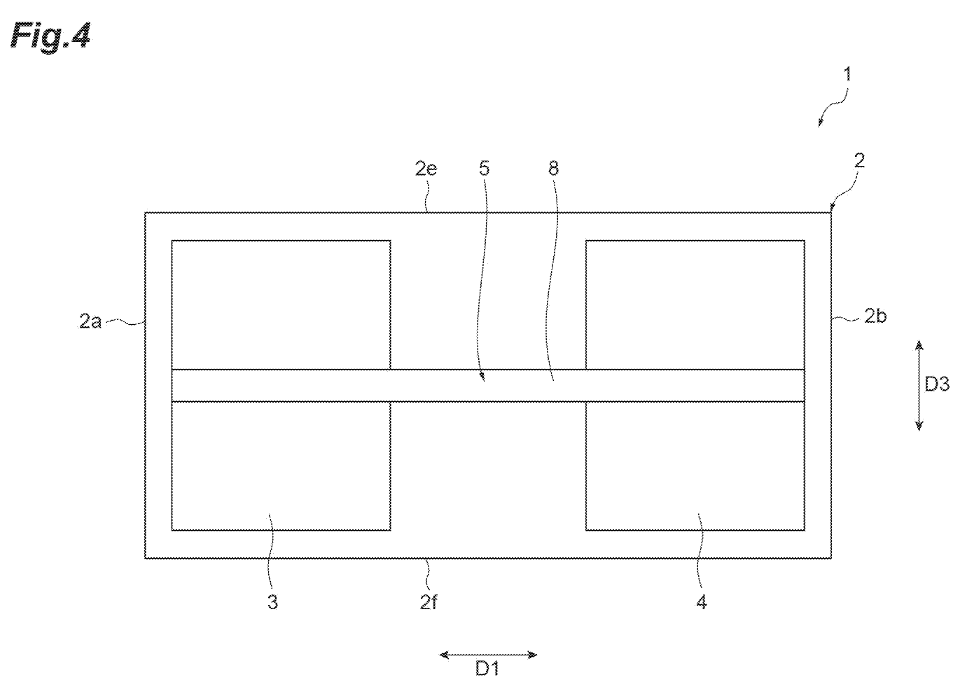

FIG. 1 is a perspective view of an inductor component according to a first embodiment. FIG. 2 is a view of the inductor component illustrated in FIG. 1 as viewed from a side of one end surface. FIG. 3 is a view of the inductor component illustrated in FIG. 1 as viewed from a side of one side surface. FIG. 4 is a view of the inductor component illustrated in FIG. 1 as viewed from a side of one main surface. As illustrated in FIGS. 1-4, an inductor component 1 includes an element body 2, a first terminal electrode 3, a second terminal electrode 4, and an inductor 5.

The element body 2 has a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, an opposing direction of the end surfaces 2a and 2b is referred to as a first direction D1, an opposing direction of the main surfaces 2c and 2d is referred to as a second direction (one direction) D2, and an opposing direction of the side surfaces 2e and 2f is referred to as a third direction D3. The first direction D1, the second direction D2, and the third direction D3 are substantially orthogonal to each other.

The end surfaces 2a and 2b extend in the second direction D2 so as to connect the main surfaces 2c and 2d. The end surfaces 2a and 2b also extend in the third direction D3 so as to connect the side surfaces 2e and 2f. The main surfaces 2c and 2d extend in the first direction D1 to connect the end surfaces 2a and 2b. The main surfaces 2c and 2d also extend in the third direction D3 so as to connect the side surfaces 2e and 2f. The side surfaces 2e and 2f extend in the first direction D1 to connect the end surfaces 2a and 2b. The side surfaces 2e and 2f also extend in the second direction D2 so as to connect the main surfaces 2c and 2d.

The main surface 2d is a mounting surface; for example, when the inductor component 1 is mounted on another electronic device (for example, a circuit base material or an inductor component) (not illustrated), the main surface 2d faces the other electronic device. The end surfaces 2a and 2b are surfaces continuing from the mounting surface (that is, the main surface 2d).

In the case of the forms illustrated in FIG. 1, a length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, each of the end surfaces 2a and 2b, the main surfaces 2c and 2d, and the side surfaces 2e and 2f has a rectangular shape. The length in the second direction D2 of the element body 2 may be substantially equal to the length in the third direction D3 of the element body 2, or may be longer than the length in the third direction D3 of the element body 2.

In the present embodiment, “equal” may mean not only “equal” but also a value including a minute difference, a manufacturing error, or the like in a preset range. For example, when a plurality of values is included within a range of ±5% of an average value of the plurality of values, the plurality of values is defined to be equal.

The element body 2 is formed by laminating a plurality of element body layers (insulating layers) in the second direction D2. That is, a laminating direction of the element body 2 is the second direction D2. In the actual element body 2, the plurality of element body layers may be integrated to such an extent that boundaries between the layers cannot be visually recognized, or may be integrated such that the boundaries between the layers can be visually recognized.

The element body 2 has visible light permeability (transparency). The element body 2 has a predetermined light transmittance. The element body 2 is formed of a material having permeability. The element body layer constituting the element body 2 may be, for example, a resin layer. A material of the element body layer includes, for example, at least one selected from a liquid crystal polymer, a polyimide resin, crystalline polystyrene, an epoxy resin, an acrylic resin, a bismaleimide-based resin, and a fluorine-based resin. The element body layer may contain a filler. The filler may be, for example, an inorganic filler. Examples of the inorganic filler include silica (SiO₂). Note that the element body layer may not contain a filler.

Note that the element body layer may be configured to contain a magnetic material. The magnetic material of the element body layer includes, for example, a Ni-Cu-Zn-based ferrite material, a Ni-Cu-Zn-Mg-based ferrite material, or a Ni-Cu-based ferrite material. The magnetic material of the element body layer may contain, for example, a Fe alloy. The element body layer may contain, for example, a nonmagnetic material. The nonmagnetic material of the element body layer includes, for example, a glass ceramic material or a dielectric material.

Each of the first terminal electrode 3 and the second terminal electrode 4 is provided in the element body 2. Each of the first terminal electrode 3 and the second terminal electrode 4 is disposed on the main surface 2d of the element body 2. The first terminal electrode 3 and the second terminal electrode 4 are provided in the element body 2 so as to be separated from each other in the first direction D1. Specifically, the first terminal electrode 3 is disposed on a side of the end surface 2a of the element body 2. The second terminal electrode 4 is disposed on a side of the end surface 2b of the element body 2.

Each of the first terminal electrode 3 and the second terminal electrode 4 may have, for example, an oblong shape (rectangular shape). Each of the first terminal electrode 3 and the second terminal electrode 4 is disposed such that each side is along the first direction D1 or the third direction D3. As shown in FIG. 2, the respective surfaces of the first terminal electrode 3 and the second terminal electrode 4 are flush with the main surface 2d. That is, in the present embodiment, the first terminal electrode 3 and the second terminal electrode 4 do not protrude from the main surface 2d. It can also be said that the first terminal electrode 3 and the second terminal electrode 4 are exposed to the main surface 2d. The first terminal electrode 3 and the second terminal electrode 4 are formed of a conductive material (for example, Cu).

Each of the first terminal electrode 3 and the second terminal electrode 4 may be provided with a plating layer (not illustrated) containing, for example, Ni, Sn, Au, or the like by electrolytic plating or non-electrolytic plating. The plating layer may have, for example, a Ni plating film containing Ni and covering the first terminal electrode 3 and the second terminal electrode 4, and an Au plating film containing Au and covering the Ni plating film.

The inductor 5 is disposed in the element body 2. The inductor 5 includes a first pillar (first conductor) 6, a second pillar (second conductor) 7, and a coupling conductor 8. The inductor 5 is configured by electrically connecting the first pillar 6, the second pillar 7, and the coupling conductor 8. An inductor axis of the inductor 5 is provided along the third direction D3. The first pillar 6, the second pillar 7, and the coupling conductor 8 are formed of a conductive material. In the present embodiment, the first pillar 6, the second pillar 7, and the coupling conductor 8 are formed of a material containing Cu as a main component. The first pillar 6, the second pillar 7, and the coupling conductor 8 are disposed apart from the end surfaces 2a and 2b, the main surfaces 2c and 2d, and the side surfaces 2e and 2f.

The first pillar 6 is disposed at a position closer to the end surface 2a of the element body 2 in the first direction D1. The first pillar 6 is disposed at a central position in the third direction D3. The first pillar 6 extends along the second direction D2. In the present embodiment, the first pillar 6 has a prismatic shape. The shape of the cross section of the first pillar 6 (the cross-sectional shape in a direction orthogonal to the second direction D2) is rectangular. The first pillar 6 can be configured by laminating a plurality of pillar members in the second direction D2. The pillar member has, for example, a square frustum shape. One end portion (one end: end portion on a side of the main surface 2d) of the first pillar 6 is connected to the first terminal electrode 3. The first pillar 6 is connected to an edge of the first terminal electrode 3 on a side of the end surface 2a. The other end portion (the other end: end portion on a side of the main surface 2c) of the first pillar 6 is connected to the coupling conductor 8.

The second pillar 7 is disposed at a position closer to the end surface 2b of the element body 2 in the first direction D1. The second pillar 7 is disposed at a central position in the third direction D3. The first pillar 6 and the second pillar 7 are disposed at positions facing each other in the first direction D1. The second pillar 7 extends along the second direction D2. In the present embodiment, the second pillar 7 has a prismatic shape. The shape of the cross section of the second pillar 7 (the cross-sectional shape in a direction orthogonal to the second direction D2) is rectangular. The second pillar 7 can be configured by laminating a plurality of pillar members in the second direction D2. The pillar member has, for example, a square frustum shape. One end portion of the second pillar 7 is connected to the second terminal electrode 4. The second pillar 7 is connected to an edge of the second terminal electrode 4 on a side of the end surface 2b. The other end portion of the second pillar 7 is connected to the coupling conductor 8.

The coupling conductor 8 is disposed at a position closer to the main surface 2c of the element body 2. The coupling conductor 8 is disposed at a position closer to the main surface 2c than the center in the second direction D2. The coupling conductor 8 extends along the first direction D1. The coupling conductor 8 connects the first pillar 6 and the second pillar 7. The coupling conductor 8 is stretched between the first pillar 6 and the second pillar 7. In the present embodiment, the coupling conductor 8 has a prismatic shape. The shape of the cross section of the coupling conductor 8 is rectangular. One end portion (end portion on a side of the end surface 2a) of the coupling conductor 8 in the extending direction is connected to the other end portion of the first pillar 6. The other end portion (end portion on a side of the end surface 2b) of the coupling conductor 8 in the extending direction is connected to the other end portion of the second pillar 7.

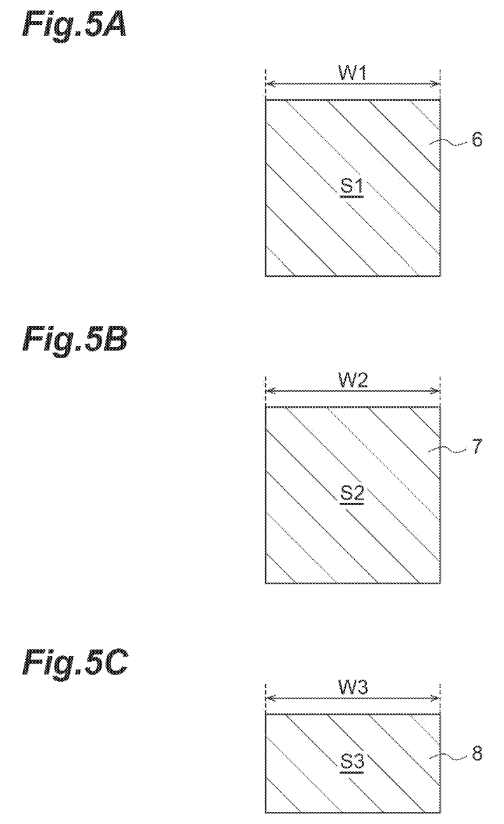

FIG. 5A is a view illustrating a cross section of the first pillar 6, FIG. 5B is a view illustrating a cross section of the second pillar 7, and FIG. 5C is a view illustrating a cross section of the coupling conductor 8. The cross sections of the first pillar 6 and the second pillar 7 illustrated in FIGS. 5A and 5B are planes orthogonal to the second direction D2. The cross section of the coupling conductor 8 illustrated in FIG. 5C is a plane orthogonal to the first direction D1.

In the present embodiment, a width W1 of the first pillar 6, a width W2 of the second pillar 7, and a width W3 of the coupling conductor 8 are the same (W1 = W2 = W3). The width W1, the width W2, and the width W3 are widths in the third direction D3.

The cross-sectional area of a cross section S1 of the first pillar 6 is the same as the cross-sectional area of a cross section S2 of the second pillar 7. The cross-sectional area of the cross section S1 of the first pillar 6 and the cross-sectional area of the cross section S2 of the second pillar 7 are larger than the cross-sectional area of a cross section S3 of the coupling conductor 8. The cross section S1 of the first pillar 6 is a cross section of a portion having the smallest area in the first pillar 6. That is, the cross-sectional area of the cross section S1 of the first pillar 6 is the cross-sectional area of the cross section at the portion having the smallest area in the first pillar 6. The cross section S2 of the second pillar 7 is a cross section of a portion having the smallest area in the second pillar 7. That is, the cross-sectional area of the cross section S2 of the second pillar 7 is the cross-sectional area of the cross section at the portion having the smallest area in the second pillar 7.

The cross-sectional area of the cross section S1 of the first pillar 6 is 0.02 times or more the cross-sectional area of a plane orthogonal to the second direction D2 of the first terminal electrode 3. The cross-sectional area of the cross section S1 of the first pillar 6 is 0.02 times or more and 1.0 times or less, and preferably 0.05 times or more and 1.0 times or less the cross-sectional area of the first terminal electrode 3. The cross-sectional area of the cross section S2 of the second pillar 7 is 0.02 times or more the cross-sectional area of a plane orthogonal to the second direction D2 of the second terminal electrode 4. The cross-sectional area of the cross section S2 of the second pillar 7 is 0.02 times or more and 1.0 times or less, and preferably 0.05 times or more and 1.0 times or less the cross-sectional area of the second terminal electrode 4.

The inductor component 1 can be manufactured, for example, as follows. The element body 2 can be formed by laminating sheets constituting the element body layer. The inductor 5 (the first pillar 6, the second pillar 7, and the coupling conductor 8) can be manufactured by using a photolithography method. The “photolithography method” is not limited by a type of a mask or the like as long as a layer to be processed containing a photosensitive material is processed into a desired pattern by exposing and developing the layer.

First, a conductor constituting the coupling conductor 8 is formed on a sheet constituting the element body layer by a photolithography method. Subsequently, after a conductor constituting the first pillar 6 and the second pillar 7 is formed by the photolithography method, sheets constituting the element body layer are laminated. Subsequently, the sheet is polished by grind polishing to expose and planarize the conductor. This processing is repeated a predetermined number of times, and thus, the first pillar 6 and the second pillar 7 are formed.

Subsequently, after a conductor constituting the first pillar 6 and the second pillar 7 is formed by the photolithography method, sheets constituting the element body layer are laminated. Subsequently, the sheet is polished by grind polishing to expose the conductors and planarize the sheets. Then, the first terminal electrode 3 and the second terminal electrode 4 are formed so as to be connected to the first pillar 6 and the second pillar 7. As described above, the inductor component 1 is obtained.

As described above, in the inductor component 1 according to the present embodiment, the cross-sectional area of the cross section S1 of the first pillar 6 and the cross-sectional area of the cross section S2 of the second pillar 7 are larger than the cross-sectional area of the cross section S3 of the coupling conductor 8. As described above, in the inductor component 1, the inductance value of the inductor 5 can be reduced by making the cross-sectional area of the cross section S1 of the first pillar 6 and the cross-sectional area of the cross section S2 of the second pillar 7 larger than the cross-sectional area of the coupling conductor 8. As a result, in the inductor component 1, the inductance value can be adjusted by the coupling conductor 8 after the inductance value is reduced. Therefore, in the inductor component 1, the inductance value can be easily adjusted (set).

In the inductor component 1 according to the present embodiment, the element body 2 is formed of a material having light permeability. In this configuration, the internal structure of the element body 2 can be confirmed. Therefore, in the inductor component 1, a surface other than the main surface (mounting surface) 2d of the element body 2 on which the first terminal electrode 3 and the second terminal electrode 4 are disposed can be visually distinguished based on the internal structure of the element body 2.

In the inductor component 1 according to the present embodiment, the coupling conductor 8 is disposed at a position closer to the main surface 2c than the center in the second direction D2 in the element body 2. In this configuration, since the coupling conductor 8 is disposed at a position closer to the main surface 2c than the center in the second direction D2, the coupling conductor 8 can be visually recognized from the main surface 2c side when the element body 2 is formed of a material having light permeability. As a result, in the inductor component 1, a surface other than the main surface 2d of the element body 2 on which the first terminal electrode 3 and the second terminal electrode 4 are disposed can be visually distinguished.

In the inductor component 1 according to the present embodiment, a width W1 of the first pillar 6, a width W2 of the second pillar 7, and a width W3 of the coupling conductor 8 are the same (W1 = W2 = W3). In this configuration, it is possible to suppress that the cross-sectional area between the first pillar 6 and the coupling conductor 8 and between the second pillar 7 and the coupling conductor 8 changes rapidly (at once). As a result, in the inductor component 1, it is possible to suppress a decrease in a Q value due to a rapid change in the cross-sectional area.

In the inductor component 1 according to the present embodiment, the cross-sectional area of the cross section S1 of the first pillar 6 is 0.02 times or more the cross-sectional area of a plane orthogonal to the second direction D2 of the first terminal electrode 3. The cross-sectional area of the cross section S2 of the second pillar 7 is 0.02 times or more the cross-sectional area of a plane orthogonal to the second direction D2 of the second terminal electrode 4. In this configuration, it is possible to suppress that the cross-sectional area between the first pillar 6 and the first terminal electrode 3 and between the second pillar 7 and the second terminal electrode 4 changes rapidly. As a result, in the inductor component 1, it is possible to suppress a decrease in a Q value due to a rapid change in the cross-sectional area.

### Second Embodiment

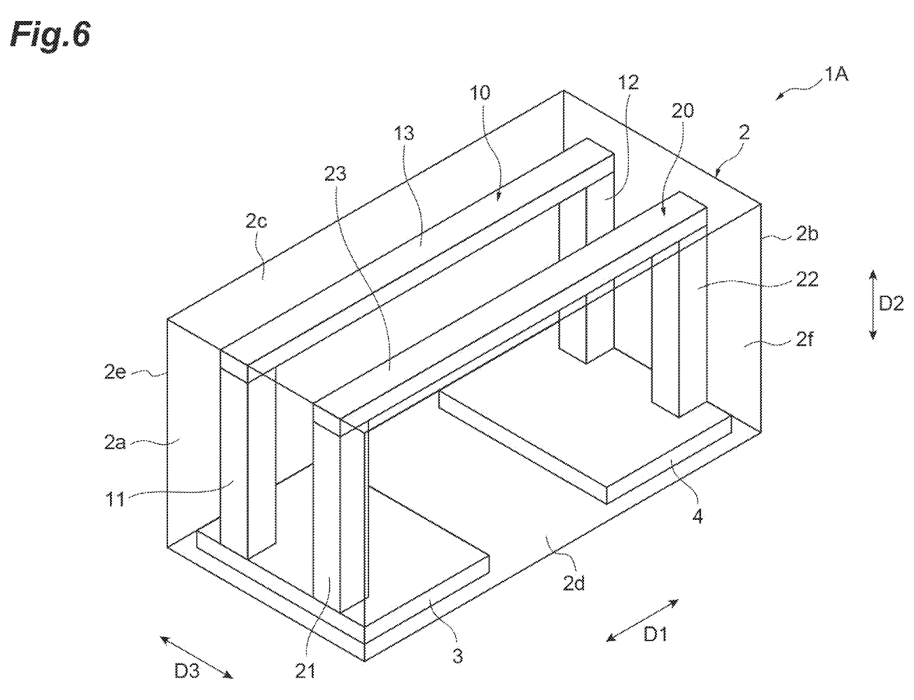

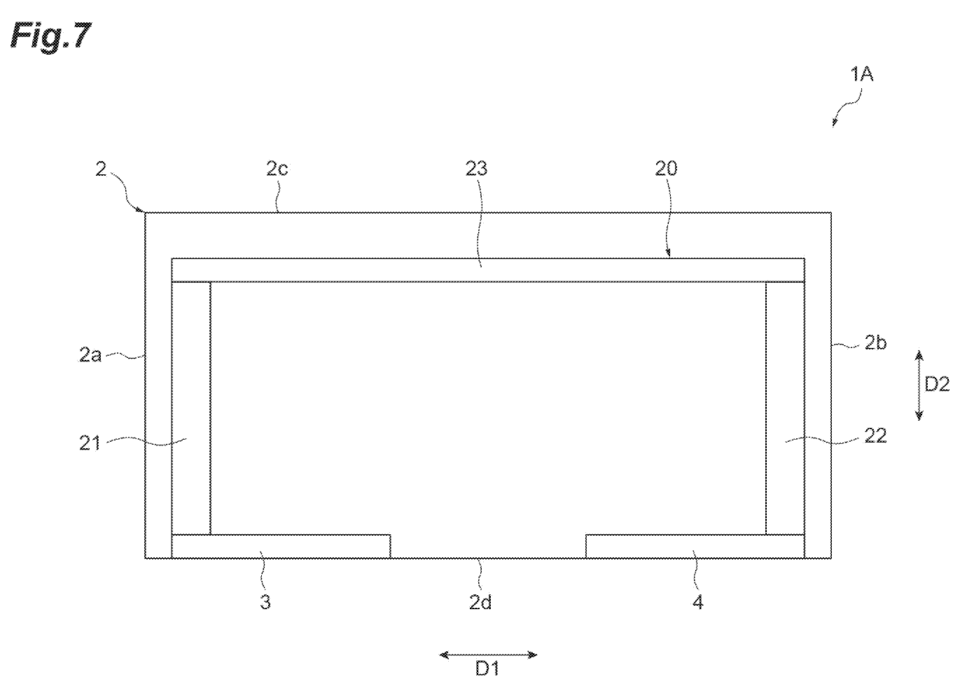

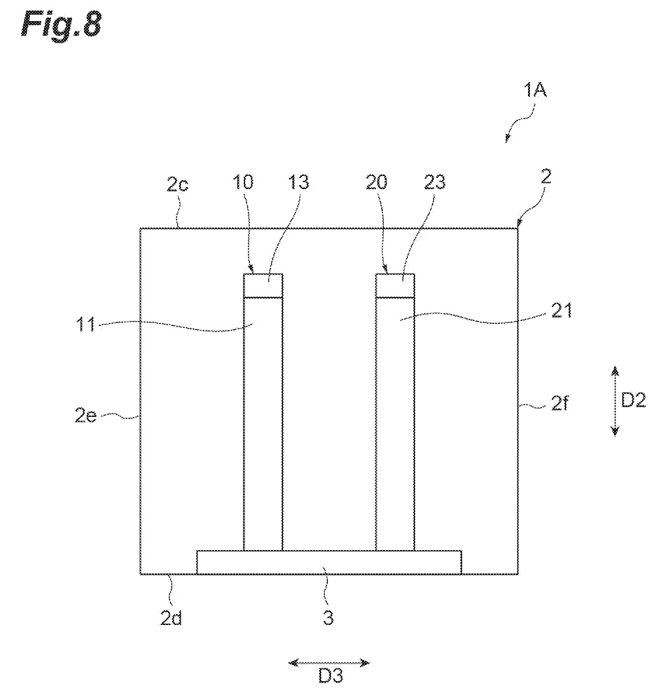

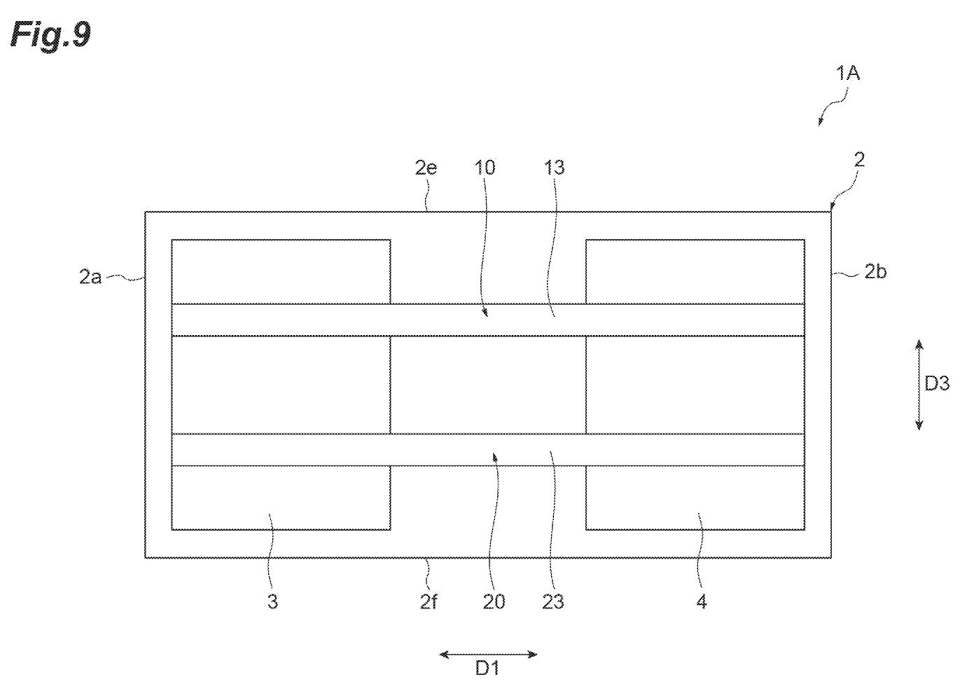

Next, a second embodiment will be described. FIG. 6 is a perspective view of an inductor component according to a second embodiment. FIG. 7 is a view of the inductor component illustrated in FIG. 6 as viewed from a side of one end surface. FIG. 8 is a view of the inductor component illustrated in FIG. 6 as viewed from a side of one side surface. FIG. 9 is a view of the inductor component illustrated in FIG. 6 as viewed from a side of one main surface. As illustrated in FIGS. 6-9, an inductor component 1A includes an element body 2, a first terminal electrode 3, a second terminal electrode 4, and two inductors 10 and 20.

The inductors 10 and 20 are disposed in the element body 2. The inductor 10 and the inductor 20 are arranged side by side in the third direction D3. The inductor 10 and the inductor 20 are arranged at a predetermined interval in the third direction D3. The inductor 10 is disposed at a position closer to the side surface 2e in the third direction D3. The inductor 20 is disposed at a position closer to the side surface 2f in the third direction D3. The inductor 10 and the inductor 20 have the same configuration. The inductor 10 and the inductor 20 are electrically connected in parallel.

The inductor 10 includes a first pillar (first conductor) 11, a second pillar (second conductor) 12, and a coupling conductor 13. The inductor 10 is configured by electrically connecting the first pillar 11, the second pillar 12, and the coupling conductor 13. An inductor axis of the inductor 10 is provided along the third direction D3. The first pillar 11, the second pillar 12, and the coupling conductor 13 are formed of a conductive material. In the present embodiment, the first pillar 11, the second pillar 12, and the coupling conductor 13 are formed of a material containing Cu as a main component. The first pillar 11, the second pillar 12, and the coupling conductor 13 are disposed apart from the end surfaces 2a and 2b, the main surfaces 2c and 2d, and the side surfaces 2e and 2f.

The first pillar 11 is disposed at a position closer to the end surface 2a of the element body 2 in the first direction D1. The first pillar 11 is disposed at a position closer to the side surface 2e in the third direction D3. The first pillar 11 extends along the second direction D2. In the present embodiment, the first pillar 11 has a prismatic shape. The shape of the cross section of the first pillar 11 (the cross-sectional shape in a direction orthogonal to the second direction D2) is rectangular. The first pillar 11 can be configured by laminating a plurality of pillar members in the second direction D2. The pillar member has, for example, a square frustum shape. One end portion (one end: end portion on a side of the main surface 2d) of the first pillar 11 is connected to the first terminal electrode 3. The first pillar 11 is connected to an edge of the first terminal electrode 3 on a side of the end surface 2a. The other end portion (the other end: end portion on a side of the main surface 2c) of the first pillar 11 is connected to the coupling conductor 13.

The second pillar 12 is disposed at a position closer to the end surface 2b of the element body 2 in the first direction D1. The second pillar 12 is disposed at a position closer to the side surface 2e in the third direction D3. The first pillar 11 and the second pillar 12 are disposed at positions facing each other in the first direction D1. The second pillar 12 extends along the second direction D2. In the present embodiment, the second pillar 12 has a prismatic shape. The shape of the cross section of the second pillar 12 (the cross-sectional shape in a direction orthogonal to the second direction D2) is rectangular. The second pillar 12 can be configured by laminating a plurality of pillar members in the second direction D2. The pillar member has, for example, a square frustum shape. One end portion of the second pillar 12 is connected to the second terminal electrode 4. The second pillar 12 is connected to an edge of the second terminal electrode 4 on a side of the end surface 2b. The other end portion of the second pillar 12 is connected to the coupling conductor 13.

The coupling conductor 13 is disposed at a position closer to the main surface 2c of the element body 2. The coupling conductor 13 is disposed at a position closer to the main surface 2c than the center in the second direction D2. The coupling conductor 13 extends along the first direction D1. The coupling conductor 13 connects the first pillar 11 and the second pillar 12. The coupling conductor 13 is stretched between the first pillar 11 and the second pillar 12. In the present embodiment, the coupling conductor 13 has a prismatic shape. The shape of the cross section of the coupling conductor 13 is rectangular. One end portion (end portion on a side of the end surface 2a) of the coupling conductor 13 in the extending direction is connected to the other end portion of the first pillar 11. The other end portion (end portion on a side of the end surface 2b) of the coupling conductor 13 in the extending direction is connected to the other end portion of the second pillar 12.

The inductor 20 includes a first pillar (first conductor) 21, a second pillar (second conductor) 22, and a coupling conductor 23. The inductor 20 is configured by electrically connecting the first pillar 21, the second pillar 22, and the coupling conductor 23. An inductor axis of the inductor 20 is provided along the third direction D3. The first pillar 21, the second pillar 22, and the coupling conductor 23 are formed of a conductive material. In the present embodiment, the first pillar 21, the second pillar 22, and the coupling conductor 23 are formed of a material containing Cu as a main component. The first pillar 21, the second pillar 22, and the coupling conductor 23 are disposed apart from the end surfaces 2a and 2b, the main surfaces 2c and 2d, and the side surfaces 2e and 2f.

The first pillar 21 is disposed at a position closer to the end surface 2a of the element body 2 in the first direction D1. The first pillar 21 is disposed at a position closer to the side surface 2f in the third direction D3. The first pillar 21 extends along the second direction D2. In the present embodiment, the first pillar 21 has a prismatic shape. The shape of the cross section of the first pillar 21 (the cross-sectional shape in a direction orthogonal to the second direction D2) is rectangular. The first pillar 21 can be configured by laminating a plurality of pillar members in the second direction D2. The pillar member has, for example, a square frustum shape. One end portion (one end: end portion on a side of the main surface 2d) of the first pillar 21 is connected to the first terminal electrode 3. The first pillar 21 is connected to an edge of the first terminal electrode 3 on a side of the end surface 2a. The other end portion (the other end: end portion on a side of the main surface 2c) of the first pillar 21 is connected to the coupling conductor 23.

The second pillar 22 is disposed at a position closer to the end surface 2b of the element body 2 in the first direction D1. The second pillar 22 is disposed at a position closer to the side surface 2f in the third direction D3. The first pillar 21 and the second pillar 22 are disposed at positions facing each other in the first direction D1. The second pillar 22 extends along the second direction D2. In the present embodiment, the second pillar 22 has a prismatic shape. The shape of the cross section of the second pillar 22 (the cross-sectional shape in a direction orthogonal to the second direction D2) is rectangular. The second pillar 22 can be configured by laminating a plurality of pillar members in the second direction D2. The pillar member has, for example, a square frustum shape. One end portion of the second pillar 22 is connected to the second terminal electrode 4. The second pillar 22 is connected to an edge of the second terminal electrode 4 on a side of the end surface 2b. The other end portion of the second pillar 22 is connected to the coupling conductor 23.

The coupling conductor 23 is disposed at a position closer to the main surface 2c of the element body 2. The coupling conductor 23 is disposed at a position closer to the main surface 2c than the center in the second direction D2. The coupling conductor 23 extends along the first direction D1. The coupling conductor 23 connects the first pillar 21 and the second pillar 22. The coupling conductor 23 is stretched between the first pillar 21 and the second pillar 22. In the present embodiment, the coupling conductor 23 has a prismatic shape. The shape of the cross section of the coupling conductor 23 is rectangular. One end portion (end portion on a side of the end surface 2a) of the coupling conductor 23 in the extending direction is connected to the other end portion of the first pillar 21. The other end portion (end portion on a side of the end surface 2b) of the coupling conductor 23 in the extending direction is connected to the other end portion of the second pillar 22.

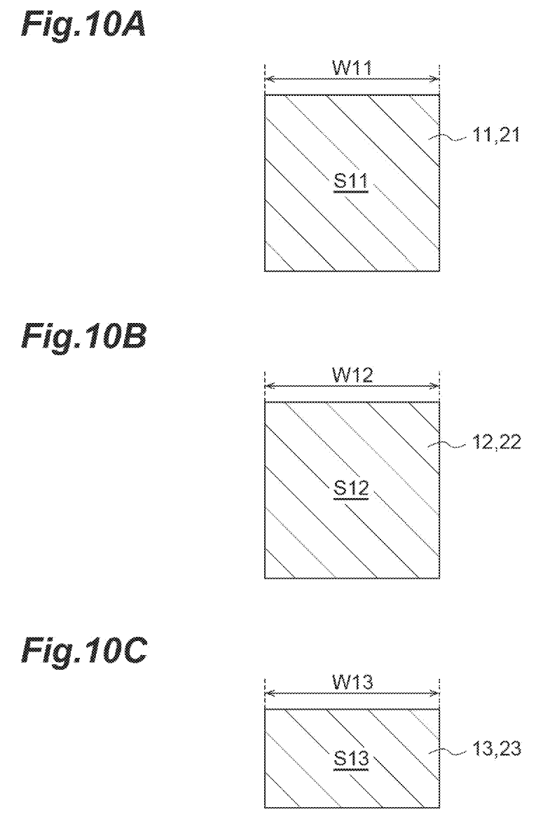

FIG. 10A is a view illustrating a cross section of the first pillars 11 and 21, FIG. 10B is a view illustrating a cross section of the second pillars 12 and 22, and FIG. 10C is a view illustrating a cross section of the coupling conductors 13 and 23. The cross sections of the first pillars 11 and 21 and the second pillars 12 and 22 illustrated in FIGS. 10A and 10B are planes orthogonal to the second direction D2. The cross section of the coupling conductors 13 and 23 illustrated in FIG. 10C is a plane orthogonal to the first direction D1.

In the present embodiment, a width W11 of the first pillars 11 and 21, a width W12 of the second pillars 12 and 22, and a width W13 of the coupling conductors 13 and 23 are the same (W11 = W12 = W13). The width W11, the width W12, and the width W13 are widths in the third direction D3.

The cross-sectional area of a cross section S11 of the first pillars 11 and 21 is the same as the cross-sectional area of a cross section S12 of the second pillars 12 and 22. The cross-sectional area of the cross section S11 of the first pillars 11 and 21 and the cross-sectional area of the cross section S12 of the second pillars 12 and 22 are larger than the cross-sectional area of a cross section S13 of the coupling conductors 13 and 23. The cross section S11 of the first pillars 11 and 21 is a cross section of a portion having the smallest area in the first pillars 11 and 21. That is, the cross-sectional area of the cross section S11 of the first pillars 11 and 21 is the cross-sectional area of the cross section at the portion having the smallest area in the first pillars 11 and 21. The cross section S12 of the second pillars 12 and 22 is a cross section of a portion having the smallest area in the second pillars 12 and 22. That is, the cross-sectional area of the cross section S12 of the second pillars 12 and 22 is the cross-sectional area of the cross section at the portion having the smallest area in the second pillars 12 and 22.

The cross-sectional area of the cross section S11 of the first pillars 11 and 21 is 0.02 times or more the cross-sectional area of a plane orthogonal to the second direction D2 of the first terminal electrode 3. The cross-sectional area of the cross section S11 of the first pillars 11 and 21 is 0.02 times or more and 1.0 times or less, and preferably 0.05 times or more and 1.0 times or less the cross-sectional area of the first terminal electrode 3. The cross-sectional area of the cross section S12 of the second pillars 12 and 22 is 0.02 times or more the cross-sectional area of a plane orthogonal to the second direction D2 of the second terminal electrode 4. The cross-sectional area of the cross section S12 of the second pillars 12 and 22 is 0.02 times or more and 1.0 times or less, and preferably 0.05 times or more and 1.0 times or less the cross-sectional area of the second terminal electrode 4.

As described above, in the inductor component 1A according to the present embodiment, the cross-sectional area of the cross section S11 of the first pillars 11 and 21 and the cross-sectional area of the cross section S12 of the second pillars 12 and 22 are larger than the cross-sectional area of the cross section S13 of the coupling conductors 13 and 23. As described above, in the inductor component 1A, the inductance value of the inductors 10 and 20 can be reduced by making the cross-sectional area of the first pillars 11 and 21 and the cross-sectional area of the second pillars 12 and 22 larger than the cross-sectional area of the coupling conductors 13 and 23. As a result, in the inductor component 1A, the inductance value can be adjusted by the coupling conductors 13 and 23 after the inductance value is reduced. Therefore, in the inductor component 1A, the inductance value can be easily adjusted (set).

### Third Embodiment

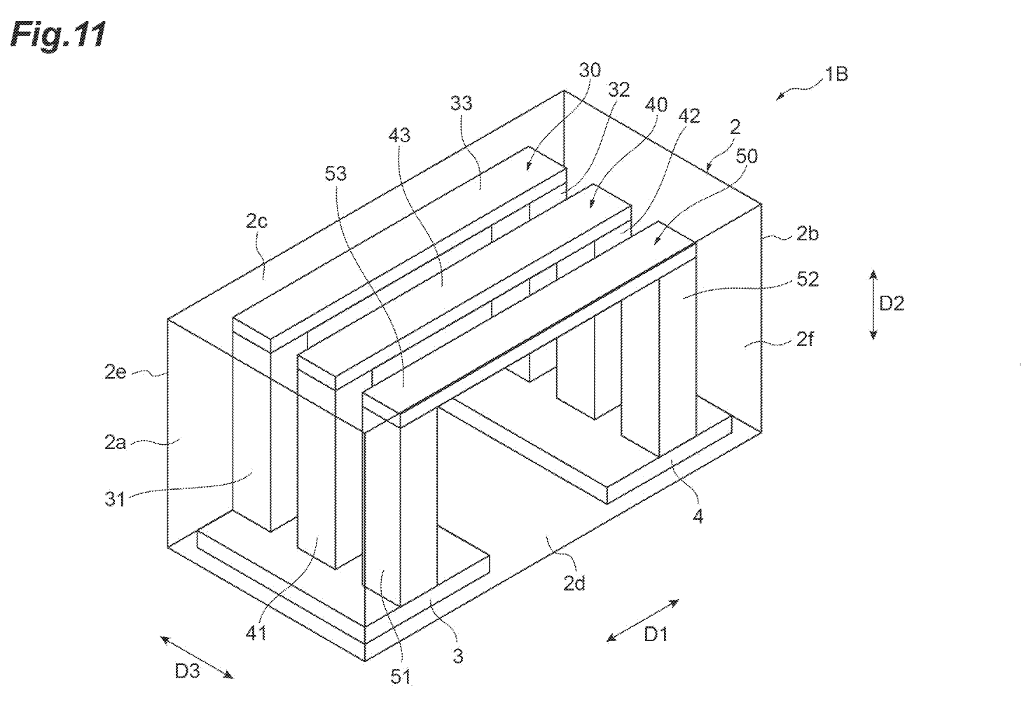

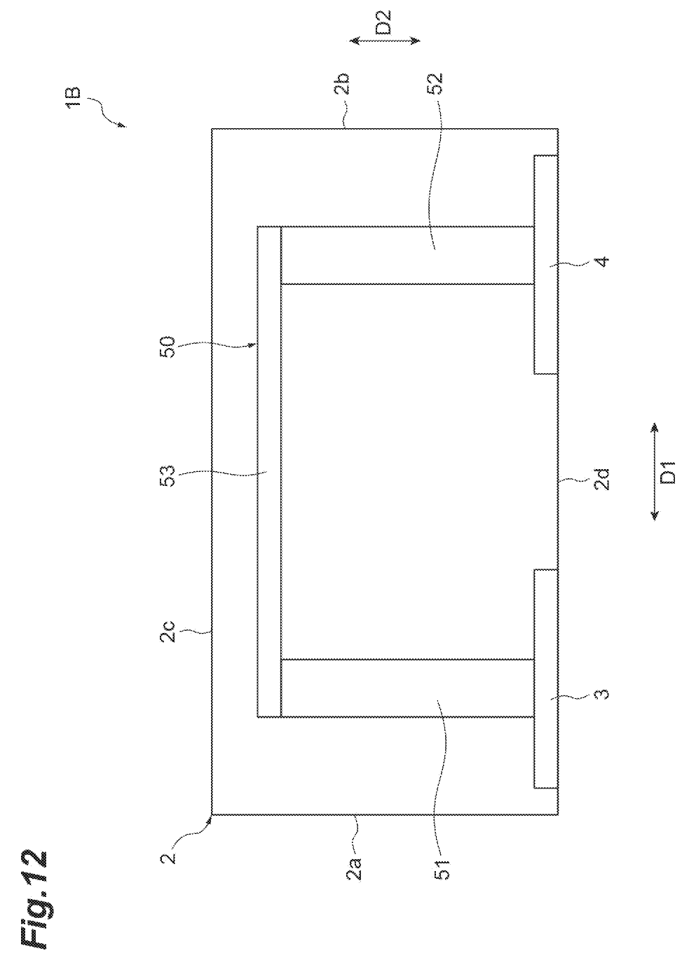

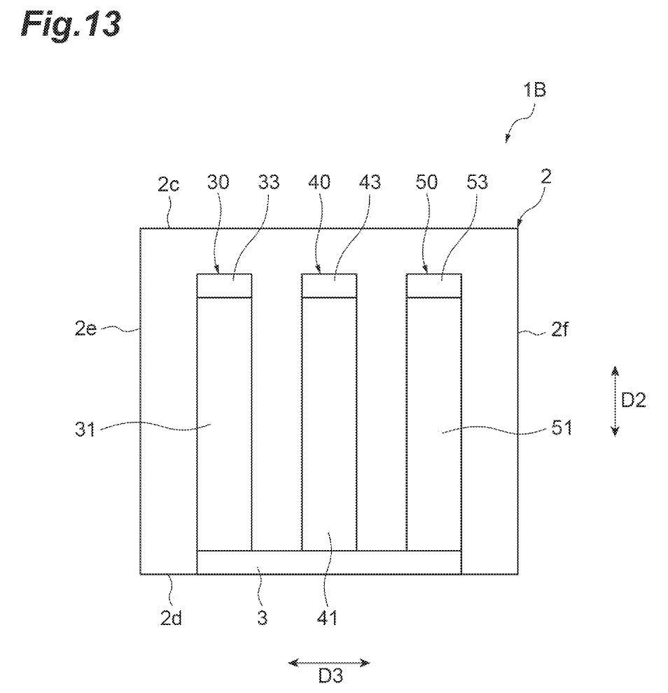

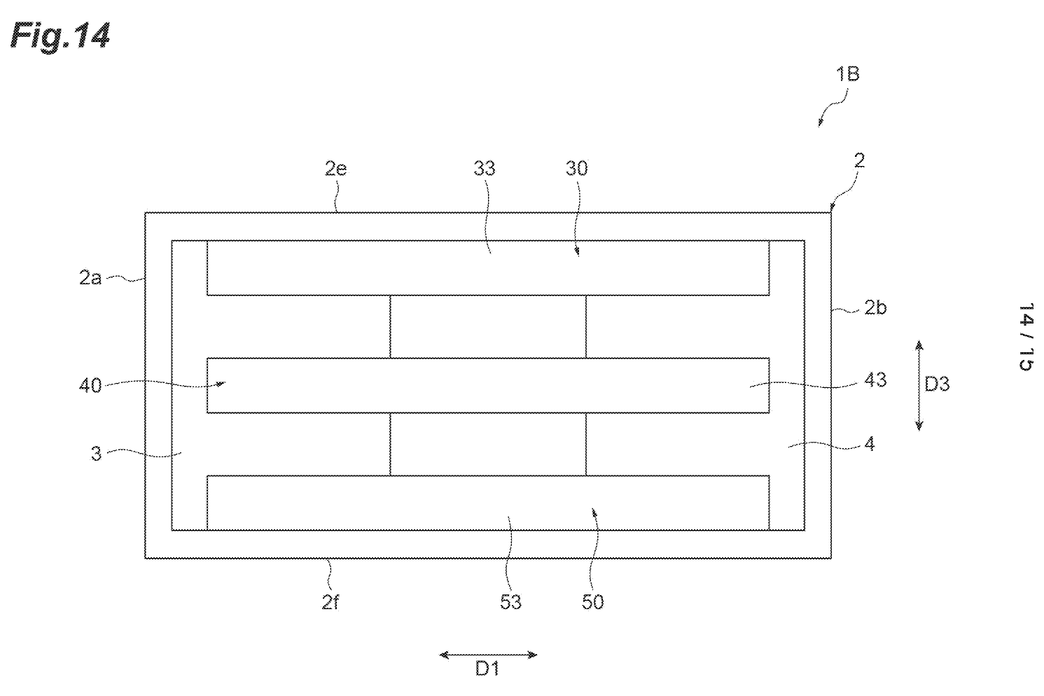

Next, a third embodiment will be described. FIG. 11 is a perspective view of an inductor component according to a third embodiment. FIG. 12 is a view of the inductor component illustrated in FIG. 11 as viewed from a side of one end surface. FIG. 13 is a view of the inductor component illustrated in FIG. 11 as viewed from a side of one side surface. FIG. 14 is a view of the inductor component illustrated in FIG. 11 as viewed from a side of one main surface. As illustrated in FIGS. 11-14, an inductor component 1B includes an element body 2, a first terminal electrode 3, a second terminal electrode 4, and three inductors 30, 40, and 50.

The inductors 30, 40, and 50 are disposed in the element body 2. The inductor 30, the inductor 40, and the inductor 50 are arranged side by side in the third direction D3. The inductor 30, the inductor 40, and the inductor 50 are arranged at a predetermined interval in the third direction D3. The inductor 30 is disposed at a position closer to the side surface 2e in the third direction D3. The inductor 40 is disposed at a central position in the third direction D3. The inductor 50 is disposed at a position closer to the side surface 2f in the third direction D3. The inductor 30, the inductor 40, and the inductor 50 have the same configuration. The inductor 30, the inductor 40, and the inductor 50 are electrically connected in parallel.

The inductor 30 includes a first pillar (first conductor) 31, a second pillar (second conductor) 32, and a coupling conductor 33. The inductor 30 is configured by electrically connecting the first pillar 31, the second pillar 32, and the coupling conductor 33. An inductor axis of the inductor 30 is provided along the third direction D3. The first pillar 31, the second pillar 32, and the coupling conductor 33 are formed of a conductive material. In the present embodiment, the first pillar 31, the second pillar 32, and the coupling conductor 33 are formed of a material containing Cu as a main component. The first pillar 31, the second pillar 32, and the coupling conductor 33 are disposed apart from the end surfaces 2a and 2b, the main surfaces 2c and 2d, and the side surfaces 2e and 2f.

The first pillar 31 is disposed at a position closer to the end surface 2a of the element body 2 in the first direction D1. The first pillar 31 is disposed at a position closer to the side surface 2e in the third direction D3. The first pillar 31 extends along the second direction D2. In the present embodiment, the first pillar 31 has a prismatic shape. The shape of the cross section of the first pillar 31 (the cross-sectional shape in a direction orthogonal to the second direction D2) is rectangular. The first pillar 31 can be configured by laminating a plurality of pillar members in the second direction D2. The pillar member has, for example, a square frustum shape. One end portion (one end: end portion on a side of the main surface 2d) of the first pillar 31 is connected to the first terminal electrode 3. The first pillar 31 is connected to a central position in the first direction D1 in the first terminal electrode 3. The other end portion (the other end: end portion on a side of the main surface 2c) of the first pillar 31 is connected to the coupling conductor 33.

The second pillar 32 is disposed at a position closer to the end surface 2b of the element body 2 in the first direction D1. The second pillar 32 is disposed at a position closer to the side surface 2e in the third direction D3. The first pillar 31 and the second pillar 32 are disposed at positions facing each other in the first direction D1. The second pillar 32 extends along the second direction D2. In the present embodiment, the second pillar 32 has a prismatic shape. The shape of the cross section of the second pillar 32 (the cross-sectional shape in a direction orthogonal to the second direction D2) is rectangular. The second pillar 32 can be configured by laminating a plurality of pillar members in the second direction D2. The pillar member has, for example, a square frustum shape. One end portion of the second pillar 32 is connected to the second terminal electrode 4. The second pillar 32 is connected to a central position in the first direction D1 in the second terminal electrode 4. The other end portion of the second pillar 32 is connected to the coupling conductor 33.

The coupling conductor 33 is disposed at a position closer to the main surface 2c of the element body 2. The coupling conductor 33 is disposed at a position closer to the main surface 2c than the center in the second direction D2. The coupling conductor 33 extends along the first direction D1. The coupling conductor 33 connects the first pillar 31 and the second pillar 32. The coupling conductor 33 is stretched between the first pillar 31 and the second pillar 32. In the present embodiment, the coupling conductor 33 has a prismatic shape. The shape of the cross section of the coupling conductor 33 is rectangular. One end portion (end portion on a side of the end surface 2a) of the coupling conductor 33 in the extending direction is connected to the other end portion of the first pillar 31. The other end portion (end portion on a side of the end surface 2b) of the coupling conductor 33 in the extending direction is connected to the other end portion of the second pillar 32.

The inductor 40 includes a first pillar (first conductor) 41, a second pillar (second conductor) 42, and a coupling conductor 43. The inductor 40 is configured by electrically connecting the first pillar 41, the second pillar 42, and the coupling conductor 43. An inductor axis of the inductor 40 is provided along the third direction D3. The first pillar 41, the second pillar 42, and the coupling conductor 43 are formed of a conductive material. In the present embodiment, the first pillar 41, the second pillar 42, and the coupling conductor 43 are formed of a material containing Cu as a main component. The first pillar 41, the second pillar 42, and the coupling conductor 43 are disposed apart from the end surfaces 2a and 2b, the main surfaces 2c and 2d, and the side surfaces 2e and 2f.

The first pillar 41 is disposed at a position closer to the end surface 2a of the element body 2 in the first direction D1. The first pillar 41 is disposed at a central position in the third direction D3. The first pillar 41 extends along the second direction D2. In the present embodiment, the first pillar 41 has a prismatic shape. The shape of the cross section of the first pillar 41 (the cross-sectional shape in a direction orthogonal to the second direction D2) is rectangular. The first pillar 41 can be configured by laminating a plurality of pillar members in the second direction D2. The pillar member has, for example, a square frustum shape. One end portion (one end: end portion on a side of the main surface 2d) of the first pillar 41 is connected to the first terminal electrode 3. The first pillar 41 is connected to a central position in the first direction D1 in the first terminal electrode 3. The other end portion (the other end: end portion on a side of the main surface 2c) of the first pillar 41 is connected to the coupling conductor 43.

The second pillar 42 is disposed at a position closer to the end surface 2b of the element body 2 in the first direction D1. The second pillar 42 is disposed at a central position in the third direction D3. The first pillar 41 and the second pillar 42 are disposed at positions facing each other in the first direction D1. The second pillar 42 extends along the second direction D2. In the present embodiment, the second pillar 42 has a prismatic shape. The shape of the cross section of the second pillar 42 (the cross-sectional shape in a direction orthogonal to the second direction D2) is rectangular. The second pillar 42 can be configured by laminating a plurality of pillar members in the second direction D2. The pillar member has, for example, a square frustum shape. One end portion of the second pillar 42 is connected to the second terminal electrode 4. The second pillar 42 is connected to a central position in the first direction D1 in the second terminal electrode 4. The other end portion of the second pillar 42 is connected to the coupling conductor 43.

The coupling conductor 43 is disposed at a position closer to the main surface 2c of the element body 2. The coupling conductor 43 is disposed at a position closer to the main surface 2c than the center in the second direction D2. The coupling conductor 43 extends along the first direction D1. The coupling conductor 43 connects the first pillar 41 and the second pillar 42. The coupling conductor 43 is stretched between the first pillar 41 and the second pillar 42. In the present embodiment, the coupling conductor 43 has a prismatic shape. The shape of the cross section of the coupling conductor 43 is rectangular. One end portion (end portion on a side of the end surface 2a) of the coupling conductor 43 in the extending direction is connected to the other end portion of the first pillar 41. The other end portion (end portion on a side of the end surface 2b) of the coupling conductor 43 in the extending direction is connected to the other end portion of the second pillar 42.

The inductor 50 includes a first pillar (first conductor) 51, a second pillar (second conductor) 52, and a coupling conductor 53. The inductor 50 is configured by electrically connecting the first pillar 51, the second pillar 52, and the coupling conductor 53. An inductor axis of the inductor 50 is provided along the third direction D3. The first pillar 51, the second pillar 52, and the coupling conductor 53 are formed of a conductive material. In the present embodiment, the first pillar 51, the second pillar 52, and the coupling conductor 53 are formed of a material containing Cu as a main component. The first pillar 51, the second pillar 52, and the coupling conductor 53 are disposed apart from the end surfaces 2a and 2b, the main surfaces 2c and 2d, and the side surfaces 2e and 2f.

The first pillar 51 is disposed at a position closer to the end surface 2a of the element body 2 in the first direction D1. The first pillar 51 is disposed at a position closer to the side surface 2f in the third direction D3. The first pillar 51 extends along the second direction D2. In the present embodiment, the first pillar 51 has a prismatic shape. The shape of the cross section of the first pillar 51 (the cross-sectional shape in a direction orthogonal to the second direction D2) is rectangular. The first pillar 51 can be configured by laminating a plurality of pillar members in the second direction D2. The pillar member has, for example, a square frustum shape. One end portion (one end: end portion on a side of the main surface 2d) of the first pillar 51 is connected to the first terminal electrode 3. The first pillar 51 is connected to a central position in the first direction D1 in the first terminal electrode 3. The other end portion (the other end: end portion on a side of the main surface 2c) of the first pillar 51 is connected to the coupling conductor 53.

The second pillar 52 is disposed at a position closer to the end surface 2b of the element body 2 in the first direction D1. The second pillar 52 is disposed at a position closer to the side surface 2f in the third direction D3. The first pillar 51 and the second pillar 52 are disposed at positions facing each other in the first direction D1. The second pillar 52 extends along the second direction D2. In the present embodiment, the second pillar 52 has a prismatic shape. The shape of the cross section of the second pillar 52 (the cross-sectional shape in a direction orthogonal to the second direction D2) is rectangular. The second pillar 52 can be configured by laminating a plurality of pillar members in the second direction D2. The pillar member has, for example, a square frustum shape. One end portion of the second pillar 52 is connected to the second terminal electrode 4. The second pillar 52 is connected to a central position in the first direction D1 in the second terminal electrode 4. The other end portion of the second pillar 52 is connected to the coupling conductor 53.

The coupling conductor 53 is disposed at a position closer to the main surface 2c of the element body 2. The coupling conductor 53 is disposed at a position closer to the main surface 2c than the center in the second direction D2. The coupling conductor 53 extends along the first direction D1. The coupling conductor 53 connects the first pillar 51 and the second pillar 52. The coupling conductor 53 is stretched between the first pillar 51 and the second pillar 52. In the present embodiment, the coupling conductor 53 has a prismatic shape. The shape of the cross section of the coupling conductor 53 is rectangular. One end portion (end portion on a side of the end surface 2a) of the coupling conductor 53 in the extending direction is connected to the other end portion of the first pillar 51. The other end portion (end portion on a side of the end surface 2b) of the coupling conductor 53 in the extending direction is connected to the other end portion of the second pillar 52.

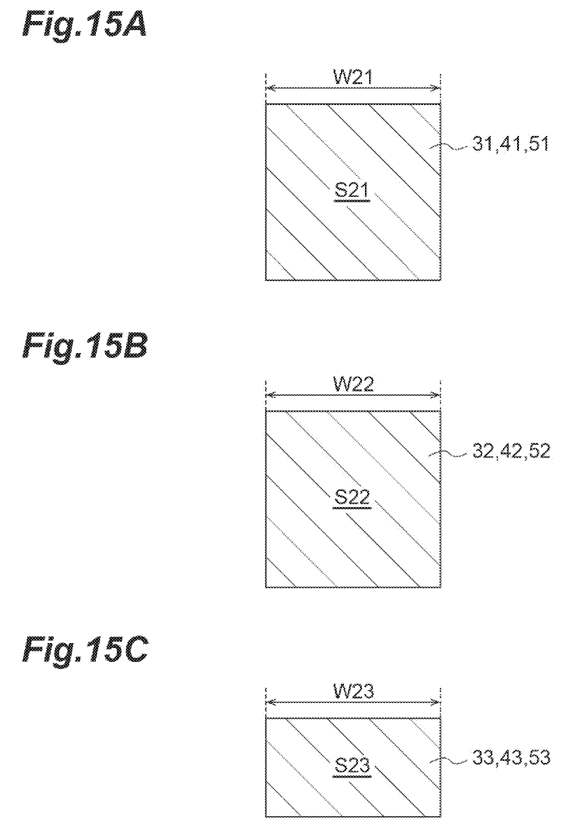

FIG. 15A is a view illustrating a cross section of the first pillars 31, 41, and 51, FIG. 15B is a view illustrating a cross section of the second pillars 32, 42, and 52, and FIG. 15C is a view illustrating a cross section of the coupling conductors 33, 43, and 53. The cross sections of the first pillars 31, 41, and 51 and the second pillars 32, 42, and 52 illustrated in FIGS. 15A and 15B are planes orthogonal to the second direction D2. The cross section of the coupling conductors 33, 43, and 53 illustrated in FIG. 15C is a plane orthogonal to the first direction D1.

In the present embodiment, a width W21 of the first pillars 31, 41, and 51, a width W22 of the second pillars 32, 42, and 52, and a width W23 of the coupling conductors 33, 43, and 53 are the same (W21 = W22 = W23). The width W21, the width W22, and the width W23 are widths in the third direction D3.

The cross-sectional area of a cross section S21 of the first pillars 31, 41, and 51 is the same as the cross-sectional area of a cross section S22 of the second pillars 32, 42, and 52. The cross-sectional area of the cross section S21 of the first pillars 31, 41, and 51 and the cross-sectional area of the cross section S22 of the second pillars 32, 42, and 52 are larger than the cross-sectional area of a cross section S23 of the coupling conductors 33, 43, and 53. The cross section S21 of the first pillars 31, 41, and 51 is a cross section of a portion having the smallest area in the first pillars 31, 41, and 51. That is, the cross-sectional area of the cross section S21 of the first pillars 31, 41, and 51 is the cross-sectional area of the cross section at the portion having the smallest area in the first pillars 31, 41, and 51. The cross section S22 of the second pillars 32, 42, and 52 is a cross section of a portion having the smallest area in the second pillars 32, 42, and 52. That is, the cross-sectional area of the cross section S22 of the second pillars 32, 42, and 52 is the cross-sectional area of the cross section at the portion having the smallest area in the second pillars 32, 42, and 52.

The cross-sectional area of the cross section S21 of the first pillars 31, 41, and 51 is 0.02 times or more the cross-sectional area of a plane orthogonal to the second direction D2 of the first terminal electrode 3. The cross-sectional area of the cross section S21 of the first pillars 31, 41, and 51 is 0.02 times or more and 1.0 times or less, and preferably 0.05 times or more and 1.0 times or less the cross-sectional area of the first terminal electrode 3. The cross-sectional area of the cross section S22 of the second pillars 32, 42, and 52 is 0.02 times or more the cross-sectional area of a plane orthogonal to the second direction D2 of the second terminal electrode 4. The cross-sectional area of the cross section S22 of the second pillars 32, 42, and 52 is 0.02 times or more and 1.0 times or less, and preferably 0.05 times or more and 1.0 times or less the cross-sectional area of the second terminal electrode 4.

As described above, in the inductor component 1B according to the present embodiment, the cross-sectional area of the cross section S21 of the first pillars 31, 41, and 51 and the cross-sectional area of the cross section S22 of the second pillars 32, 42, and 52 are larger than the cross-sectional area of the cross section S23 of the coupling conductors 33, 43, and 53. As described above, in the inductor component 1B, the inductance value of the inductors 30, 40, and 50 can be reduced by making the cross-sectional area of the first pillars 31, 41, and 51 and the cross-sectional area of the second pillars 32, 42, and 52 larger than the cross-sectional area of the coupling conductors 33, 43, and 53. As a result, in the inductor component 1B, the inductance value can be adjusted by the coupling conductors 33, 43, and 53 after the inductance value is reduced. Therefore, in the inductor component 1B, the inductance value can be easily adjusted (set).

Although the embodiment of the present disclosure has been described above, the present disclosure is not necessarily limited to the above-described embodiment, and various modifications can be made without departing from the gist thereof.

In the above embodiment, a mode in which the first terminal electrode 3 and the second terminal electrode 4 are disposed only on the main surface 2d of the element body 2, that is, a mode in which the first terminal electrode 3 and the second terminal electrode 4 are bottom surface terminals has been described as an example. However, the first terminal electrode may be an L-shaped terminal disposed across the end surface 2a and the main surface 2d. Similarly, the second terminal electrode may be an L-shaped terminal disposed across the end surface 2b and the main surface 2d.

In the above embodiment, a mode in which the first pillar 6 and the second pillar 7 have the same configuration, and the cross-sectional area of the cross section S1 of the first pillar 6 and the cross-sectional area of the cross section S2 of the second pillar 7 are the same has been described as an example. However, the first pillar 6 and the second pillar 7 may have different configurations. That is, the cross-sectional area of the cross section S1 of the first pillar 6 and the cross-sectional area of the cross section S2 of the second pillar 7 may be different. The same applies to the first pillars 11 and 21, the second pillars 12 and 22, the first pillars 31, 41, and 51, and the second pillars 32, 42, and 52.

In the above embodiment, a mode in which the shapes of the cross sections of the first pillar, the second pillar, and the coupling conductor are rectangular has been described as an example. However, the shapes of the cross sections of the first pillar, the second pillar, and the coupling conductor may be any shape such as a circular shape and a polygonal shape.

In the above embodiment, a mode in which the coupling conductor 8 extends linearly has been described as an example. However, the coupling conductor 8 is not limited to a linear shape, and may be bent or curved. The same applies to the coupling conductors 13, 23, 33, 43, and 53.

In the above embodiment, a mode in which the coupling conductors 8, 13, 23, 33, 43, and 53 are disposed at a position closer to the main surface 2c than the center in the second direction D2 has been described as an example. However, the positions of the coupling conductors 8, 13, 23, 33, 43, and 53 are not limited.

In the above embodiment, a mode in which the element body 2 is formed of a material having light permeability has been described as an example. However, the element body 2 is not necessarily formed of a material having light permeability. That is, the element body 2 may be opaque.

What is claimed is:

1. An inductor component comprising:
an element body;
a pair of terminal electrodes disposed in the element body; and
an inductor disposed in the element body, wherein
the inductor includes
a first conductor extending in one direction and having one end in the one direction connected to one of the terminal electrodes,
a second conductor extending in the one direction and having one end in the one direction connected to the other terminal electrode, and
a coupling conductor connecting the other end of the first conductor in the one direction and the other end of the second conductor in the one direction, and
a cross-sectional area of a cross section orthogonal to the one direction of at least one of the first conductor and the second conductor is larger than a cross-sectional area of a cross section orthogonal to an extending direction of the coupling conductor.

2. The inductor component according to claim 1, wherein a plurality of the inductors are disposed in the element body, and
the plurality of the inductors are electrically connected in parallel.

3. The inductor component according to claim 1, wherein the element body is formed of a material having light permeability.

4. The inductor component according to claim 3, wherein the element body includes a mounting surface on which the pair of terminal electrodes is disposed, and a main surface opposed to the mounting surface in the one direction, and
the coupling conductor is disposed at a position closer to the main surface than a center in the one direction in the element body.

5. The inductor component according to claim 1, wherein the element body includes a mounting surface on which the pair of terminal electrodes is disposed, and a main surface opposed to the mounting surface in the one direction, and
the pair of terminal electrodes is disposed only on the mounting surface.

6. The inductor component according to claim 1, wherein at least one of the first conductor and the second conductor has the same width as the coupling conductor.

7. The inductor component according to claim 1, wherein the cross-sectional area of at least one of the first conductor and the second conductor is 0.02 times or more the cross-sectional area of the terminal electrode orthogonal to the one direction.

8. The inductor component according to claim 1, wherein a cross-sectional area of a cross section orthogonal to the one direction of the first conductor and a cross-sectional area of a cross section orthogonal to the one direction of the second conductor are the same.

9. The inductor component according to claim 1, wherein cross sections orthogonal to the one direction of the first conductor and the second conductor and a cross section orthogonal to the extending direction of the coupling conductor are rectangular.

10. The inductor component according to claim 1, wherein the element body has a rectangular parallelepiped shape.

11. The inductor component according to claim 1, wherein the element body is a laminate formed by laminating a plurality of element body layers in the one direction.

12. The inductor component according to claim 1, wherein the element body contains a resin.

13. The inductor component according to claim 2, wherein the plurality of the inductors are arranged side by side in a third direction orthogonal to the one direction and the extending direction of the coupling conductor.

14. The inductor component according to claim 13, wherein the plurality of the inductors are two.

15. The inductor component according to claim 13, wherein the plurality of the inductors are three.

16. The inductor component according to claim 4, wherein the pair of terminal electrodes is disposed only on the mounting surface.

17. The inductor component according to claim 5, wherein surfaces of the pair of terminal electrodes is flush with the mounting surface.

18. The inductor component according to claim 6, wherein a length in a direction orthogonal to the width in a cross section orthogonal to the one direction of at least one of the first conductor and the second conductor is larger than a length in a direction orthogonal to the width in a cross section orthogonal to the extending direction of the coupling conductor.

19. The inductor component according to claim 7, wherein the cross-sectional area of at least one of the first conductor and the second conductor is 1.0 times or less the cross-sectional area of the terminal electrode orthogonal to the one direction.

20. The inductor component according to claim 1, wherein the element body includes a mounting surface on which the pair of terminal electrodes is disposed, and a pair of end surfaces continuous from the mounting surface, one of the terminal electrodes is disposed across one of the end surfaces and the mounting surface, and the other of the terminal electrodes is disposed across the other of the end surfaces and the mounting surface.
